(19) United States
(12) Patent Application Publication
(10) Pub. No.: US 2004/0151451 A1
(43) Pub. Date: Aug. 5, 2004

(54) Optical cables and methods of repairing damaged optical cable installations

(76) Inventor: Colin Graeme Wallace, Hoole (GB)

Correspondence Address: Timothy J Aberle, PO Box 489, Hickory, NC, 28603-0489, US

(21) Appl. No.: 10/478,727

(22) PCT Filed: Nov. 2, 2001
(86) PCT No.: PCT/EP01/12700

(30) Foreign Application Priority Data
May 26, 2001 (GB) 0112895.8

(51) Int. Cl. G02B 6/02

(52) U.S. Cl. 385/123

(57) ABSTRACT

An optical cable incorporates at least one fibre with positive dispersion and at least one fibre with negative dispersion spliced together within the cable. In the simpler forms of the invention, the aggregate dispersion from end to end of the cable is close to zero. The cable is intended for use in repairing a dispersion-managed optical cable installation in circumstances where it is not possible to replace a short damaged lenght of cable along its original route and it is necessary to insert such additional lenght of cable that the dispersion balance of the system may be adversely affected. If required, the cable may be modified (with an aggregate dispersion different from zero) to make it possible to match the dispersion of the damaged cable length that was removed instead of neglecting it.

This invention relates to optical cables and to the use of those cables in repairing damaged optical cable installations.

If the potential capacity of a large-scale optical cable installation is to be realised, it is necessary to manage (among other things) the chromatic dispersion that tends to broaden light pulses as they travel through a fibre. One satisfactory way of doing so is to construct the installation of different types of fibre whose lengths and dispersion characteristics (at least one positive and one negative) are chosen to ensure that the aggregate dispersion nowhere exceeds a value at which reliability of signal transmission would be compromised, and preferably such that the aggregate dispersion of a signal,pulse over its whole path is close to zero.

In initial installation, this can be achieved by careful system design and dimensional control, preferably with splices between positive and negative dispersion fibres (which are more difficult than those between similar fibres) made at convenient sites, ideally indoors. In most cases, repair where a cable has been damaged can be made without too much difficulty by cutting out the damaged section and splicing in a similar length of new cable with the same dispersion characteristics: a little extra fibre length will be required to make the two splices per fibre required to re-establish connection, but this will normally be insignificant.

Problems can arise, however, where the circumstances of the damage preclude immediate direct replacement of the damaged cable length. For example, if a cable installed alongside a railway were to be damaged incidentally to a railway accident, or a cable anywhere in a terrorist incident, access to the immediate damage site might be denied for a number of weeks pending various kinds of investigation, and restoration of the cable on an acceptable timescale may demand that it is re-connected, either temporarily or permanently, by cutting at the nearest points to the damaged section to which access is permitted and splicing in a length of cable sufficient to by-pass the inaccessible zone by an available and satisfactory route, which might be several kilometres long: in this case, simply splicing in a cable with the same dispersion characteristics as the damaged cable may result in those characteristics being over-represented and the system unbalanced to the point at which its performance is degraded or in the extreme it fails completely. To give an idea of scale, an additional 6 km of cable might introduce around loops/nm of additional dispersion (positive or negative, depending on the fibre type), which is enough to cause serious imbalance.

One aspect of the present invention is an optical cable, primarily intended for use in making a repair in circumstances of the kind described, comprising at least one optical fibre made up of sections of positive and negative dispersion characterised in that they are spliced together within the cable.

When the cable includes a plurality of fibres, preferably they are all made up of sections of positive and negative dispersion spliced together within the cable and preferably they all have substantially the same aggregate dispersion.

In the simplest form of the invention, suitable for use when the damaged length of cable to be replaced is reasonably short, the aggregate dispersion of the or each fibre of the cable in accordance with the invention is zero or close to it. In this case, the whole length of the cable will be inserted in place of the damaged section (or two or more cables in accordance with the invention could be inserted if required), any length not required by the length of the route being coiled or otherwise placed in some convenient disposition.

Alternatively, if it is anticipated that the dispersion due to the removed length of damaged cable may not be negligible, the cable of the invention may comprise a main section with dispersion close to zero and at least one end section with uniform positive or negative dispersion (for maximum versatility, one of each at its opposite ends), preferably corresponding to that of one of the cable types present in the system in which the cable may be used. In this case, a length of the end section matching the dispersion of the removed cable section (an equal length, if the dispersion characteristics are the same) plus the whole of its main section would be inserted, the remainder of the said end section, and the whole of the other end section if present, being discarded, or if justified reserved for use elsewhere.

Preferably the fibres at the ends of the cable, and at any position where it may be intended to cut it, are of the same kind (either all with positive dispersion, or all with negative) in order to avoid the need to make splices between dis-similar fibres in the field.

The cable in accordance with the invention will not usually be longer than about 12 or at most about 15 km.

The invention includes a method of repairing a damaged optical cable comprising removing a relatively short damaged section and replacing it with the cable described and the use of the cable for this purpose.

The invention will be further described, by way of example, with reference to the accompanying drawings in which:

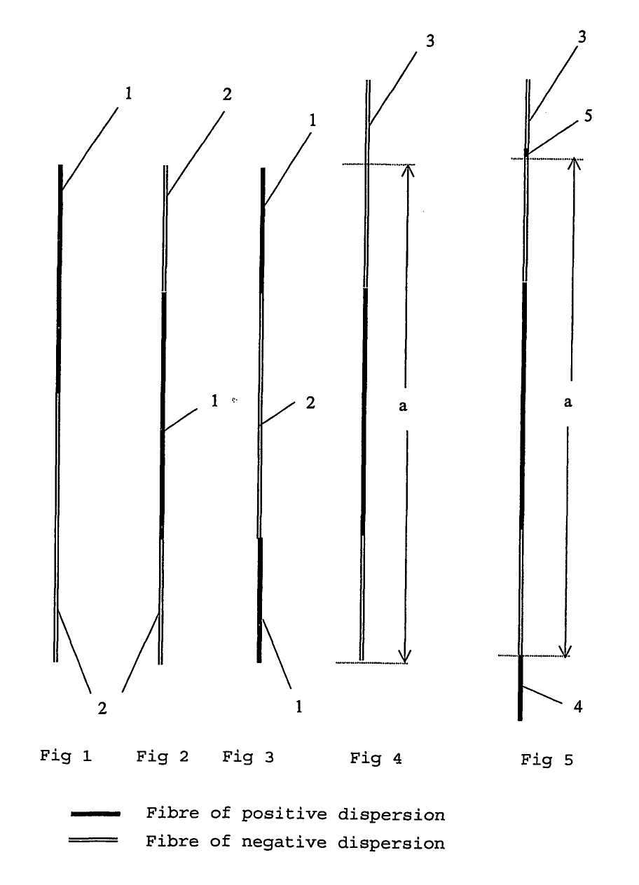

FIG. 1 is a diagrammatic representation of a simple form of optical fibre cable in accordance with the invention;

FIGS. 2 and 3 are corresponding representations of two referred forms of optical fibre cable in accordance the invention; and

FIGS. 4 and 5 are corresponding representations of two other forms optical fibre cable in accordance of the invention.

For simplicity, the drawings show only the relevant property of parts of the cable, with a thick solid line representing a portion of cable in which the fibre, or each of the fibres, has positive dispersion and a double line a portion in which the fibre, or each of the fibres, has negative dispersion, and the structure of only one fibre will be described. It should be noted, however, that there will usually be more than one fibre, and that in such a case there is no necessity for the longitudinal distribution of dispersion characteristics to be exactly the same for all of the fibres, and on the contrary it may be considered preferable that they differ at least to the extent that splices in different fibres are staggered. It is usually desirable for all the fibre ends accessible at the ends of the cable, and at any intended cutting position, to be of the same kind.

FIG. 1 shows the simplest possible form of the invention, in which a length of positive-dispersion fibre 1 and a length of negative-dispersion fibre 2 chosen to have equal and opposite dispersion are spliced together within the cable to achieve an aggregate dispersion from end to end of the cable. This is suitable for use as a whole when the dispersion due to the damaged length of cable removed can be neglected, or if this is not so it can be shortened by removing from the appropriate end a length having a dispersion approximately equal but opposite to that of the damaged cable section to be replaced; but (unless the damaged area includes a splice between positive-dispersion and negative-dispersion fibres, which is likely to be infrequent) it will require the formation of a splice between dis-similar fibres at one or other of its ends in the field.

In the preferred form of the invention shown in FIG. 2, this need is avoided (at the cost of making two such splices in the factory instead of one) by using two lengths of negative-dispersion fibre 2, one at each end of the cable. FIG. 3 shows the reverse of this arrangement, and the appropriate one of these cables is to be chosen depending whether the damaged cable exhibits negative or positive dispersion.

FIG. 4 shows a development of the invention having a length a having zero aggregate dispersion (which may be identical with the cable represented by FIG. 2) is extended by a length 3 having negative dispersion; this cable is intended for use when the damaged cable has negative dispersion and the length 3 is to be shortened so that its dispersion at least approximately equals that of the length of damaged cable removed (in most cases the dispersion per unit length of the old and new cables will be similar and it will be sufficient to shorten it to the same length as that of the removed cable length). Alternatively, since the end parts of the cable are alike, equivalent shortening could be effected at the opposite end of the cable.

It will be apparent that the cable represented by FIG. 3 could be similarly extended for use in repairing a positive-dispersion cable where the dispersion of the removed cable length cannot be neglected.

FIG. 5 represents a further development of the invention, providing a cable that can be used to repair either a positive-dispersion cable or a negative-dispersion one. Again the length a has zero aggregate dispersion and may be identical with the whole cable of FIG. 2. This is extended at its upper end (as drawn) by a length 3 of negative-dispersion fibre, broadly as for FIG. 4, and also at its lower end by a length 4 of positive-dispersion fibre; a further short length of positive-dispersion fibre 5 is inserted between the length a and the extension 3. To repair a damaged negative-dispersion cable, length 4 would be entirely cut off and discarded and length 3 shortened to obtain an aggregate dispersion about equal to that of the removed damaged section; or to repair a damaged positive-dispersion cable, length 3 would be removed together with part only of length 5 (in order to obtain a positive-dispersion end) and the length 4 shortened to obtain the appropriate aggregate dispersion to match that of the removed damaged section.

An alternative construction with all the dispersion characteristics reversed is also possible.

Especially in the forms of the invention shown in FIGS. 4 and 5 (and their reverse analogues) it may be desirable to mark the cable externally to indicate the positions of the splices and/or other reference points, particularly the end or ends of the length a.

Any discussion of the background to the invention herein is included to explain the context of the invention. Where any document or information is referred to as “known”, it is admitted only that it was known to at least one member of the public somewhere prior to the date of this application. Unless the content of the reference otherwise clearly indicates, no admission is made that such knowledge was available to the public or to experts in the art to which the invention relates in any particular country (whether a member-state of the PCT or not), nor that it was known or disclosed before the invention was made or prior to any claimed date. Further, no admission is made that any document or information forms part of the common general knowledge of the art either on a world-wide basis or in any country and it s not believed that any of it does so.

1 An optical cable comprising at least one optical fibre made up of sections of positive and negative dispersion characterised in that they are spliced together within the cable.

2 An optical cable as claimed in claim 1 including a plurality of fibres all made up of sections of positive and negative dispersion spliced together within the cable and all having substantially the same aggregate dispersion.

3 An optical cable as claimed in claim 1 or claim 2 in which the aggregate dispersion of the or each fibre is zero or close to it.

4 An optical cable as claimed in claim 1 or claim 2 comprising a main section with dispersion close to zero and at least one end section with uniform positive or negative dispersion.

5 An optical fibre cable as claimed in any one of claims 1-4 in which the fibres at the ends of the cable are of the same kind (either all with positive dispersion, or all with negative).

6 An optical fibre cable substantially as described with reference to any one Figure of the drawings.

7 A method of repairing a damaged optical cable comprising removing a relatively short damaged section and replacing it using the cable claimed in any one of claims 1-6.

8 A method of repairing a damaged optical cable comprising removing a relatively short damaged section and replacing it with substantially the whole of a cable claimed in claim 3.

9 A method of repairing a damaged optical cable comprising removing a relatively short damaged section and replacing it with substantially the whole of the main section and part of the end section of a cable claimed in claim 4 having an aggregate dispersion substantially the same as that of the section removed.

10 A method of repairing a damaged optical cable substantially as described and using a cable substantially as described with reference to any one figure of the drawings.

11 The use of a cable as claimed in any one of claims 1-6 to repair a damaged optical cable.
